(19) United States
(12) Patent Application Publication
(10) Pub. No.: US 2023/0183932 A1
(43) Pub. Date: Jun. 15, 2023

(54) Debris Scooping Device

(71) Applicant: Curt Caufield, Roland, OK (US)

(72) Inventor: Curt Caufield, Roland, OK (US)

(21) Appl. No.: 17/741,668

(22) Filed: May 11, 2022

Related U.S. Application Data
(60) Provisional application No. 63/289,249, filed on Dec. 14, 2021.

(51) Int. Cl. E01H 1/12; A01B 1/02

(52) U.S. Cl. CPC E01H 1/12; A01B 1/022

(57) ABSTRACT

The present invention relates generally to the field of debris scooping. More specifically, the present invention relates to a debris scooping device primarily comprised of a shaft, a shaft extension, and at least one head attachment. The head attachment may fixedly attach to the shaft or removably attach to the shaft via a plurality of female and male threads. The head attachment may be in the form of a shovel body, a spade body, a rake body, a spear, body, etc. such that the attachment can effectively remove debris from within a manhole. One embodiment of the device is further comprised of at least one shaft extension that can be attached to the shaft and head attachment to allow the device to increase in length.

### CROSS-REFERENCE TO RELATED APPLICATION

The present application claims priority to, and the benefit of, U.S. Provisional Application No. 63/289,249, which was filed on Dec. 14, 2021, and is incorporated herein by reference in its entirety.

### FIELD OF THE INVENTION

The present invention relates generally to the field of debris scooping. More specifically, the present invention relates to a debris scooping device primarily comprised of a shaft, a shaft extension, and at least one head attachment. The head attachment may fixedly attach to the shaft or removably attach to the shaft via a plurality of female and male threads. The head attachment may be in the form of a shovel body, a spade body, a rake body, a spear, body, etc. such that the attachment can effectively remove debris from within a manhole. One embodiment of the device is further comprised of at least one shaft extension that can be attached to the shaft and head attachment to allow the device to increase in length. Accordingly, the present disclosure makes specific reference thereto. Nonetheless, it is to be appreciated that aspects of the present invention are also equally applicable to other like applications, devices and methods of manufacture.

### BACKGROUND

When jet cleaning sewer lines, it is not uncommon for pieces of rock, pipe, or other debris to get washed into a manhole. This then requires the removal of said debris from the manhole. To accomplish this, a vacuum truck is typically used to suck the debris out from the manhole. However, not all manhole locations allow a vacuum truck to easily access the manhole. In addition, some manholes are too deep to use a common tool such as a rake to remove the debris.

Therefore, there exists a long-felt need in the art for a device that can be used to remove debris from a manhole in the event that said manhole cannot be accessed by a vacuum truck. Further, there exists a long-felt need in the art for a debris scooping device that can be used to remove debris from a manhole and wherein the device is of a sufficient length to reach the debris within the manhole. In addition, there exists a long-felt need in the art for a debris scooping device that can be customized by the user for each scenario in which the device is used.

The subject matter disclosed and claimed herein, in one embodiment thereof, comprises a debris scooping device. The device is primarily comprised of a shaft, a shaft extension, and at least one head attachment. The head attachment may fixedly attach to the shaft or removably attach to the shaft via a plurality of female and male threads. The head attachment may be in the form of a shovel body, a spade body, a rake body, a spear, body, etc. such that the attachment can effectively remove debris from within a manhole. One embodiment of the device is further comprised of at least one shaft extension that can be attached to the shaft and head attachment to allow the device to increase in length.

In this manner, the debris scooping device of the present invention accomplishes all of the forgoing objectives and provides a device that can be used to remove debris from a manhole in the event that said manhole cannot be accessed by a vacuum truck. Further, the shaft extension ensures that the device is sufficient length to reach the debris within the manhole. In addition, the head attachment of the device allows for customization by the user for each scenario in which the device is used to remove a variety of debris types.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a debris scooping device. The device is primarily comprised of a shaft, a shaft extension, and at least one head attachment. In the preferred embodiment of the device, the shaft is generally cylindrical and is manufactured from a durable metal, wood, or a rigid plastic. The shaft has a first end that is further comprised of a grip that may be manufactured from the same material as the shaft or from a textured rubber material that promotes grip. In this manner, a user can easily retain the shaft in their hand(s) while using the device.

The second end of the shaft is further comprised of a plurality of male threads. In one embodiment, the shaft is of a fixed length. In a differing embodiment, the device is comprised of at least one shaft extension that has a first end with a plurality of female threads that can engage the male threads of the second end of the shaft. Further, the second end of the extension is comprised of a plurality of male threads. Accordingly, the extension can be removably attached to the shaft to increase the overall length of the device to accommodate for manholes of differing depths.

The male threads of the shaft and/or the shaft extension are further removably attached to at least one head attachment via an opening of the attachment with a plurality of female threads. In the preferred embodiment, the attachment has a shaft and a body that is fixedly attached to the shaft in a perpendicular fashion. The body may further be attached to the shaft and support by at least one support member. In the preferred embodiment, the body is generally shovel or spade shaped. In other embodiments the body may resemble, but is not limited to, a rake, a net, a spear, etc. Therefore, a plurality of head attachments can be removably attached to the device based on the size, shape, and/or type of debris that a user desires to remove from within a manhole.

Accordingly, the debris scooping device of the present invention is particularly advantageous as it provides a device that can be used to remove debris from any manhole and wherein the device is sufficient length to reach the debris within any manhole. Furthermore, the head attachment of the device allows for customization by the user for each scenario in which the device is employed. In this manner, the debris scooping device overcomes the limitations of existing methods and devices used which are known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a debris scooping device of the present invention in accordance with the disclosed architecture;

FIG. 2 illustrates an exploded view of one potential embodiment of a debris scooping device of the present invention in accordance with the disclosed architecture; and

FIG. 3 illustrates an enhanced perspective view of one potential embodiment of a debris scooping device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can be used to remove debris from a manhole in the event that said manhole cannot be accessed by a vacuum truck. Further, there exists a long-felt need in the art for a debris scooping device that can be used to remove debris from a manhole and wherein the device is of a sufficient length to reach the debris within the manhole. In addition, there exists a long-felt need in the art for a debris scooping device that can be customized by the user for each scenario in which the device is used.

The present invention, in one exemplary embodiment, is comprised of a debris scooping device primarily comprised of a shaft, a shaft extension, and at least one head attachment. In the preferred embodiment of the device, the shaft is generally cylindrical and is manufactured from a durable metal, wood, or a rigid plastic. The shaft has a first end that is further comprised of a grip that may be manufactured from the same material as the shaft, and or a textured rubber material that promotes grip. In this manner, a user can easily retain the shaft in their hand(s) while using the device.

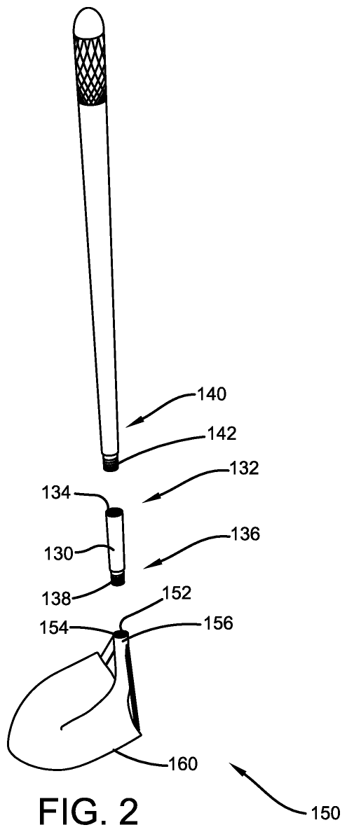

The second end of the shaft is further comprised of a plurality of male threads. In differing embodiments the shaft is of a fixed length or has at least one shaft extension (best seen in FIG. 2) that has a first end with a plurality of female threads that can engage the male threads of the second end of the shaft. Further, the second end of the extension is comprised of a plurality of male threads. Accordingly, the extension can be removably attached to the shaft to increase the overall length of the device to accommodate for manholes of differing depths.

The male threads of the shaft and/or the shaft extension are further removably attached to at least one head attachment via an opening of the attachment with a plurality of female threads. In the preferred embodiment, the attachment has a shaft and a body that is fixedly attached to the shaft in a perpendicular fashion. The body may further be attached to the shaft and support by at least one support member. In the preferred embodiment, the body is generally shovel or spade shaped. In other embodiments the body may resemble, but is not limited to, a rake, a net, a spear, etc. Therefore, a plurality of head attachments can be removably attached to the device based on the size, shape, and/or type of debris that a user desires to remove from within a manhole.

Accordingly, the debris scooping device of the present invention is particularly advantageous as it provides a device that can be used to remove debris from any manhole and wherein the device is sufficient length to reach the debris within any manhole. Furthermore, the head attachment of the device allows for customization by the user for each scenario in which the device is employed. In this manner, the debris scooping device overcomes the limitations of existing methods and devices used which are known in the art.

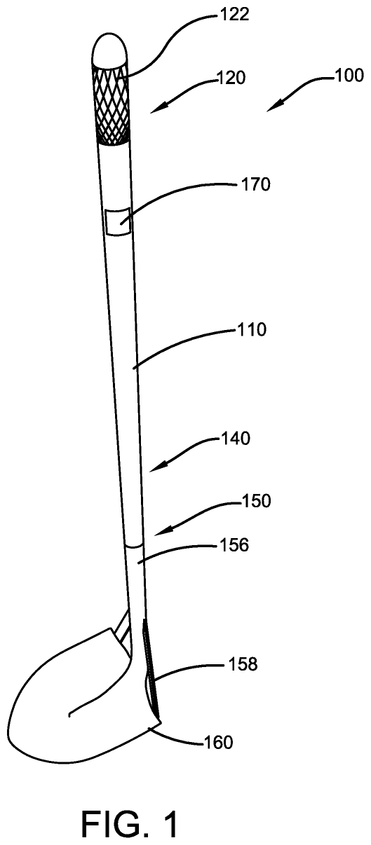

Referring initially to the drawings, FIG. 1 illustrates a perspective view of one potential embodiment of a debris scooping device 100 of the present invention in accordance with the disclosed architecture. The device 100 is primarily comprised of a shaft 110, a shaft extension 130, and at least one head attachment 160. In the preferred embodiment of the device 100, the shaft 110 is generally cylindrical and is manufactured from a durable metal such as, but not limited to, stainless steel or aluminum. The shaft 110 may also be manufactured from wood, or a rigid plastic such as, but not limited to, acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. The shaft 110 has a first end 120 that is further comprised of at least one grip 122. The grip 122 may be manufactured from the same material as the shaft 110, and or a textured rubber material that promotes grip. In this manner, a user can easily retain the shaft 110 in their hand(s) while using the device 100. It should be noted that the grip 122 is not limited to location at only the first end 120, and may be present on any location of the shaft 110.

The second end 140 of the shaft 110 is further comprised of a plurality of male threads 142. In one embodiment, the shaft 110 is of a fixed length. However, in another embodiment the device 100 is comprised of at least one shaft extension 130. The extension 130 has a first end with a plurality of female threads 134 that can engage the male threads 142 of the second end 140 of the shaft 110. The second end 136 of the extension 130 is further comprised of a plurality of male threads 138. In this manner, the extension 130 can be removably attached to the shaft 110 to increase the overall length of the device 100 to accommodate for manholes of differing depths. In an alternative embodiment, the shaft 110 may also be telescopic such that it can increase and decrease in length. In said embodiment, the shaft 110 has at least one lock 170 that allows the length of the shaft 110 to be secured in the desired position after being telescoped. In differing embodiments said lock 170 may be a lock such as, but not limited to, a rotating ring lock, a push button lock, etc.

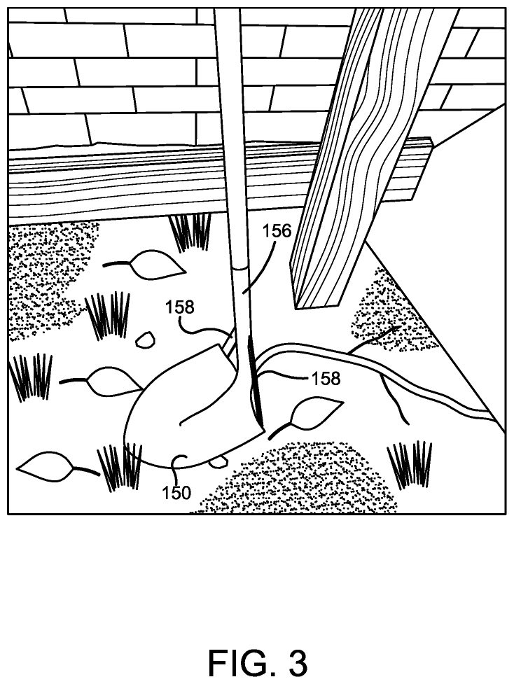

FIG. 3 illustrates an enhanced perspective view of one potential embodiment of a debris scooping device 100 of the present invention in accordance with the disclosed architecture. The male threads 142 of the shaft 110 (and/or the male threads 138 of the extension 130) further removably attach to at least one head attachment 150. The attachment has an opening 152 with a plurality of female threads 154. In this manner, the attachment 150 can removably attach to the shaft 110 and/or extension 130. In the preferred embodiment, the attachment 150 has a shaft 156 and a body 160 that is fixedly attached to the shaft 156 in a perpendicular fashion. The body 160 may further be attached to the shaft 156 and supported by at least one support member 158. In the preferred embodiment, the body 160 is generally shovel or spade shaped. However, in differing embodiments the body 160 may resemble, but is not limited to, a rake, a net, a spear, etc. In this manner, a plurality of head attachments 150 can be removably attached to the device 100 based on the size, shape, and/or type of debris that a user desires to remove from within a manhole. In a further embodiment, the head attachment may be fixedly attached to the shaft extension 130 and/or the shaft 110.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “debris scooping device” and “device” are interchangeable and refer to the debris scooping device 100 of the present invention.

Notwithstanding the forgoing, the debris scooping device 100 of the present invention and its various components can be of any suitable size and configuration as is known in the art without affecting the overall concept of the invention, provided that they accomplish the above-stated objectives. One of ordinary skill in the art will appreciate that the size, configuration and material of the debris scooping device 100 as shown in the FIGS. are for illustrative purposes only, and that many other sizes and shapes of the debris scooping device 100 are well within the scope of the present disclosure. Although the dimensions of the debris scooping device 100 are important design parameters for user convenience, the debris scooping device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A debris scooping device comprising:
a shaft having a first end and a second end with a plurality of male threads;
a grip positioned on the first end; and
a head attachment comprised of a plurality of female threads and a shovel body.

2. The debris scooping device of claim 1, wherein the plurality of female threads of the head attachment attaches to the plurality of male threads of the second end of the shaft.

3. The debris scooping device of claim 1 further comprised of a shaft extension.

4. The debris scooping device of claim 3, wherein the shaft extension attaches to the second end of the shaft to increase an overall length of the shaft.

5. The debris scooping device of claim 1, wherein each of the shaft and the head attachment is comprised of a metal, a wood or a plastic material.

6. A debris scooping device comprising:
a shaft having a first end and a second end with a plurality of male threads;
a grip;
a lock; and
a head attachment having a plurality of female threads, a head attachment shaft, a support member and a body.

7. The debris scooping device of claim 6, wherein the grip is manufactured from a rubber material.

8. The debris scooping device of claim 7, wherein the rubber material is textured.

9. The debris scooping device of claim 6, wherein the shaft is telescoping.

10. The debris scooping device of claim 9, wherein the shaft can be fixed in a desired position by the lock.

11. The debris scooping device of claim 10, wherein the lock is a rotating ring lock or a push button lock.

12. The debris scooping device of claim 6, wherein each of the shaft and the head attachment is comprised of a metal, a wood or a plastic material.

13. The debris scooping device of claim 6, wherein the grip is located on the first end of the shaft.

14. A debris scooping device comprising:
a shaft having a first end and a second end with a plurality of male threads;
a grip positioned on the first end;
a shaft extension having a first end with a plurality of female threads and a second end with a plurality of male threads; and
a head attachment further comprised of a plurality of female threads, a head attachment shaft, a support member and a body.

15. The debris scooping device of claim 14, wherein the plurality of female threads of the first end of the shaft extension can attach to the plurality of male threads of the second end of the shaft.

16. The debris scooping device of claim 14, wherein the plurality of male threads of the second end of the shaft extension can attach to the plurality of female threads of the head attachment.

17. The debris scooping device of claim 14, wherein the shaft extension increases an overall length of the shaft.

18. The debris scooping device of claim 14, wherein the body of the head attachment is perpendicular to the head attachment shaft.

19. The debris scooping device of claim 18, wherein the body is a select one of a shovel body, a spade body, a rake body, a net body and a spear body.

20. The debris scooping device of claim 14, wherein each of the shaft, the shaft extension and the head attachment is comprised of a metal, a wood or a plastic material.
